(19) United States
(12) Patent Application Publication
(10) Pub. No.: US 2026/0004812 A1
(43) Pub. Date: Jan. 1, 2026

(54) PARITY PARTITIONS FOR LINEAR TAPE

(71) Applicant: International Business Machines Corporation, Armonk, NY (US)

(72) Inventors: Mark Alfred Lantz, Adliswil (CH); Simeon Furrer, Altdorf (CH); Manuel Petermann, Zürich (CH); Ilias Iliadis, Rueschlikon (CH)

(21) Appl. No.: 18/755,090

(22) Filed: Jun. 26, 2024

(51) Int. Cl. G11B 20/18; G11B 5/008; G11B 20/12

(52) U.S. Cl. CPC G11B 20/1833; G11B 5/00813; G11B 20/1201

(57) ABSTRACT

A magnetic tape defined with one or more data partitions and one or more parity partitions is obtained, wherein each of the data partitions is separated from each of the parity partitions corresponding to the given data partition by a given minimum distance, wherein the given minimum distance is greater than a length of the magnetic tape affected by a permanent error and wherein each data partition comprises data information and each parity partition comprises in-line erasure coding information. The magnetic tape is written based on the one or more data partitions and the one or more parity partitions.

### BACKGROUND

The present invention relates generally to the electrical, electronic and computer arts and, more particularly, to storage systems.

Hyperscalers, such as large cloud service providers, are increasingly adopting erasure coding to improve the reliability of data stored on tape. In-line erasure coding is also being investigated by researchers. Erasure codes are forward error correction codes based on symbol erasures. In erasure coding, an original message of k symbols is encoded into a block of n symbols (also called a code word), where n>k. (The code rate is defined as k/n.) The original message can be recovered from the code word using only a subset of the code word's symbols. There are many different erasure coding schemes, and Maximum Distance Separable (MDS) codes, such as Reed-Solomon codes, achieve the best storage efficiency.

### BRIEF SUMMARY

Principles of the invention provide techniques for parity partitions for linear tape. In one aspect, an exemplary method includes the operations of obtaining a magnetic tape, the magnetic tape defined with one or more data partitions and one or more parity partitions, wherein each of the data partitions is separated from each of the parity partitions corresponding to the given data partition by a given minimum distance, wherein each data partition comprises data information and each parity partition comprises in-line erasure coding information and wherein the given minimum distance is greater than a length of the magnetic tape affected by a permanent error; and writing to the magnetic tape based on the one or more data partitions and the one or more parity partitions.

In one aspect, an erasure coded magnetic tape is partitioned along its length with one or more data partitions and one or more parity partitions, wherein the one or more data partitions are configured for storing data information and the one or more parity partitions are configured for storing parity information, wherein each of the one or more data partitions is separated from a corresponding parity partition by a given minimum distance, wherein the given minimum distance is greater than a length of the magnetic tape affected by a permanent error and wherein at least one of the data partitions is written with data and at least one of the parity partitions is written with parity information.

In one aspect, a computer program product includes one or more tangible computer-readable storage media and program instructions stored on at least one of the one or more tangible computer-readable storage media, the program instructions executable by a processor, the program instructions including writing erasure code data to a magnetic tape with one or more data partitions and one or more parity partitions, wherein the one or more data partitions are configured for storing data information and the one or more parity partitions are configured for storing parity information, wherein each of the one or more data partitions is separated from a corresponding parity partition by a given minimum distance and wherein the given minimum distance is greater than a length of the magnetic tape affected by a permanent error.

In one aspect, a storage system includes a memory and at least one processor, coupled to the memory, and operative to perform operations including writing erasure code data to a magnetic tape with one or more data partitions and one or more parity partition, wherein the one or more data partitions are configured for storing data information and the one or more parity partitions are configured for storing parity information, wherein each of the one or more data partitions is separated from a corresponding parity partition by a given minimum distance and wherein the given minimum distance is greater than a length of the magnetic tape affected by a permanent error.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 illustrates the segmentation of a tape into data bands and sub-bands;

FIG. 2A illustrates data written using an in-line erasure coding and the serpentine wraps of FIG. 1;

FIG. 2B illustrates an alternate technique for writing data using an in-line erasure coding;

FIG. 2C illustrates an example tape configuration to write data using an in-line erasure coding, in accordance with an example embodiment;

FIGS. 3A-3F illustrate example tape configurations to write data using in-line erasure coding, in accordance with example embodiments;

FIGS. 4A-4D illustrate example tape configurations to write data using in-line erasure coding, in accordance with example embodiments; and

FIG. 5 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Given the discussion herein (reference characters refer to the drawings discussed below), it will be appreciated that, in general terms, an exemplary method, according to an aspect of the invention, includes the operations of obtaining a magnetic tape 212, the magnetic tape 212 defined with one or more data partitions 282 and one or more parity partitions 286, wherein each of the data partitions 282 is separated from each of the parity partitions 286 corresponding to the given data partition 282 by a given minimum distance, wherein each data partition 282 comprises data information and each parity partition 286 comprises in-line erasure coding information and wherein the given minimum distance is greater than a length of the magnetic tape affected by a permanent error; and writing to the magnetic tape 212 based on the one or more data partitions 282 and the one or more parity partitions 286. In example embodiments, data written in accordance with the above technique is read in accordance with the above technique. It is noted that the techniques described above can be adapted to known tape drives by controlling the tape drives to write in accordance with the inventive techniques. The technical benefits include an erasure coding tape technique that partitions a tape along its length with separate partitions for data and parity to guarantee a physical separation between data blocks and the corresponding parity blocks; and an erasure coded tape cartridge that is partitioned along its length with separate partitions for data and parity to guarantee a physical separation between data blocks and the corresponding parity blocks.

In example embodiments, a given one of the data partitions 282 is separated from a corresponding one of the parity partitions 286 with at least one buffer zone. The technical benefits include an enhancement of storage reliability based on the added distance between partitions.

In example embodiments, a given one of the data partitions 304-1 is separated from a corresponding one of the parity partitions 286 with other data partitions 304-5, 304-6. The technical benefits include an enhancement of storage reliability based on the added distance between partitions while improving tape utilization.

In example embodiments, a given one of the data partitions 282 is separated from a corresponding one of the parity partitions 286 with other parity partitions 286. The technical benefits include an enhancement of storage reliability based on the added distance between partitions while improving tape utilization.

In example embodiments, at least one of the parity partitions 286 is located toward a beginning of the magnetic tape 212 in relation to the corresponding data partition 282. The technical benefits include efficient tape access resulting from locating a region of parity information toward the beginning of the tape and optimizing the writing efficiency in terms of time to write data.

In example embodiments, at least one of the parity partitions 286 is located toward an end of the magnetic tape 212 in relation to the corresponding data partition 282. The technical benefits include efficient tape access resulting from locating a region of parity information toward the end of the tape and optimizing the reading efficiency in terms of time to read data. This option is of interest, for example, if the parity information is rarely needed and fast data read access is a priority.

In example embodiments, the one or more data partitions 282 and one or more parity partitions 286 are defined along a length of the magnetic tape 212. The technical benefits include an erasure coded tape cartridge that is partitioned along its length with separate partitions for data and parity to guarantee a physical separation between data blocks and the corresponding parity blocks.

In one aspect, an erasure coded magnetic tape 212 is partitioned along its length with one or more data partitions 282 and one or more parity partitions 286, wherein the one or more data partitions 282 are configured for storing data information and the one or more parity partitions 286 are configured for storing parity information, wherein each of the one or more data partitions 282 is separated from a corresponding parity partition 286 by a given minimum distance, wherein the given minimum distance is greater than a length of the magnetic tape affected by a permanent error and wherein at least one of the data partitions 282 is written with data and at least one of the parity partitions 286 is written with parity information. The technical benefits include an erasure coded tape configured using a technique that partitions a tape along its length with separate partitions for data and parity to guarantee a physical separation between data blocks and the corresponding parity blocks; and an erasure coded tape cartridge that is partitioned along its length with separate partitions for data and parity to guarantee a physical separation between data blocks and the corresponding parity blocks.

In one aspect, a computer program product includes one or more tangible computer-readable storage media and program instructions stored on at least one of the one or more tangible computer-readable storage media, the program instructions executable by a processor, the program instructions including writing erasure code data to a magnetic tape 212 with one or more data partitions 282 and one or more parity partitions 286, wherein the one or more data partitions 282 are configured for storing data information and the one or more parity partitions 286 are configured for storing parity information, wherein each of the one or more data partitions 282 is separated from a corresponding parity partition 286 by a given minimum distance and wherein the given minimum distance is greater than a length of the magnetic tape affected by a permanent error. The technical benefits include an erasure coding tape controller that partitions a tape along its length with separate partitions for data and parity to guarantee a physical separation between data blocks and the corresponding parity blocks.

In one aspect, a storage system includes a memory 112 and at least one processor 110, coupled to the memory 112, and operative to perform operations including writing erasure code data to a magnetic tape 212 with one or more data partitions 282 and one or more parity partitions 286, wherein the one or more data partitions 282 are configured for storing data information and the one or more parity partitions 286 are configured for storing parity information, wherein each of the one or more data partitions 282 is separated from a corresponding parity partition 286 by a given minimum distance and wherein the given minimum distance is greater than a length of the magnetic tape affected by a permanent error. The technical benefits include an erasure coding tape controller that partitions a tape along its length with separate partitions for data and parity to guarantee a physical separation between data blocks and the corresponding parity blocks.

Host level erasure coding (EC) is often used to improve the reliability of tape systems. The EC can be done across multiple cartridges (such as a redundant array of independent tapes (RAIT)), within a cartridge (in-line EC), or as a combination of both. In-line erasure coding has the advantage of enabling the host to correct errors using the parity in the cartridge, without the need to mount additional tapes (i.e., errors are locally repairable).

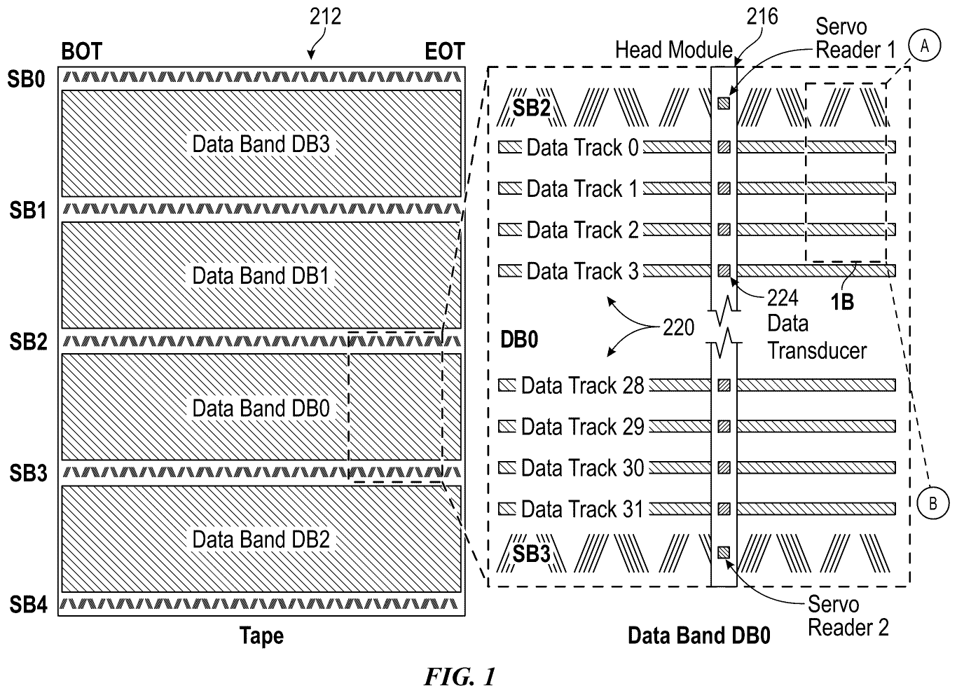

FIG. 1 illustrates the segmentation of a tape 212 into data bands and sub-bands. A write head module 216 includes a set of data (write) transducers 224 for writing data to one of the data bands. In the example of FIG. 1, the tape 212 is partitioned into four data bands DB0-DB3 with data band DB3 occupying the top portion of the tape 212 and data band DB2 occupying the bottom portion of the tape 212, as illustrated on the left-side of FIG. 1. In one example embodiment, data band DB0 is written first, data band DB1 is written second, data band DB2 is written third, and data band DB3 is written fourth.

As illustrated in the center of FIG. 1, the write head module 216 is configured to write to data band DB0. The write head module 216 includes 32 data transducers 224 and thus can write data to 32 data tracks 220 in parallel. It is noted that write head modules 216 with fewer than or greater than 32 data transducers 224 are contemplated.

As illustrated on the right-side of FIG. 1, after the write head module 216 reaches one end of the tape 212, the write head module 216 is moved up or down to write another wrap w0, w1, w2, w3, w4 of the corresponding data band DB0-DB3, the direction of the tape drive is reversed, and the write head module 216 continues writing data to the tape 212. The writing of data continues in a serpentine fashion where the data being written is allowed to partially overlap with the immediately neighboring wrap w0, w1, w2, w3, w4, as described further below.

The right side of FIG. 1 illustrates the writing of data by three of the data transducers 224 of the write head module 216. As noted above, each data transducer 224 writes data in a serpentine fashion. Thus, wrap 0 is written is one direction, wrap 1 is written in the opposite direction and wrap 2 is written in the original direction. Also, as noted above, data being written is allowed to partially overlap with data of the previously written immediately neighboring wrap. Thus, wrap 2 is allowed to partially overlap with the data of the immediately neighboring wrap 0 (and overlaps with the data of the immediately neighboring wrap 4 after wrap 4 is written). There is a sufficiently large area of wrap 0 that is non-overlapping with wrap 2 to enable a read transducer (not shown) to recover the data written in wrap 0. This process is known as shingled track recording, analogous to laying overlapping shingles on a roof.

It is noted that it is not conventionally possible to control the physical location along the length of tape of data written to tape to ensure that data and parity blocks with a large logical separation do not reside physically near each other on the tape 212, such as near each other in adjacent, or nearly adjacent, wraps. As such, the source of a permanent error when reading a data block (such as a servo error) may also lead to a permanent error in reading the parity in the adjacent wrap. This uncertainty makes it difficult to analyze and guarantee data reliability.

In one example embodiment, the tape is partitioned along its length into separate data and parity partitions to guarantee a large physical separation between data and the corresponding parity information. For example, for a (n,k)=(24,20) erasure code (EC) having 4 parity blocks for each 20 data blocks, approximately ⅚ of the length of the tape is used for the data partition and approximately ⅙ of the length of the tape is used for the parity partition with a small buffer between the two partitions. In some embodiments, a relatively larger region may be used for the parity partition to account for the lower compressibility of parity blocks. (Other example error codes include 4+1 (one parity block for each 4 data blocks) and 5+2 (two parity blocks for each 5 data blocks). As used herein, a block refers to a segment or subset of information.) The parity partition can be further partitioned into sub-partitions (e.g., 2, 3, 4, or more sub-partitions) to further guarantee a physical separation between the parity blocks and/or the data blocks, as described more fully below. Parity partitions could be located at the beginning of the tape, the end of the tape, or distributed along the length of the tape. Similarly, the data partition can be further partitioned into sub-partitions (e.g., 2, 3, 4 or more sub-partitions) to further guarantee a physical separation between the parity blocks and/or the data blocks, as described more fully below.

Moreover, as illustrated on the right side of FIG. 1, a first data block at the beginning of wrap 0 may be relatively distant from, for example, its corresponding parity block when measured in a linear manner. The parity block may, however, reside at the end of wrap w1 or at the beginning of wrap w2, and thus be relatively close to the first data block. Thus, if this area of the tape is corrupted, both the data block and its corresponding parity block may be corrupted, making the data potentially unrecoverable.

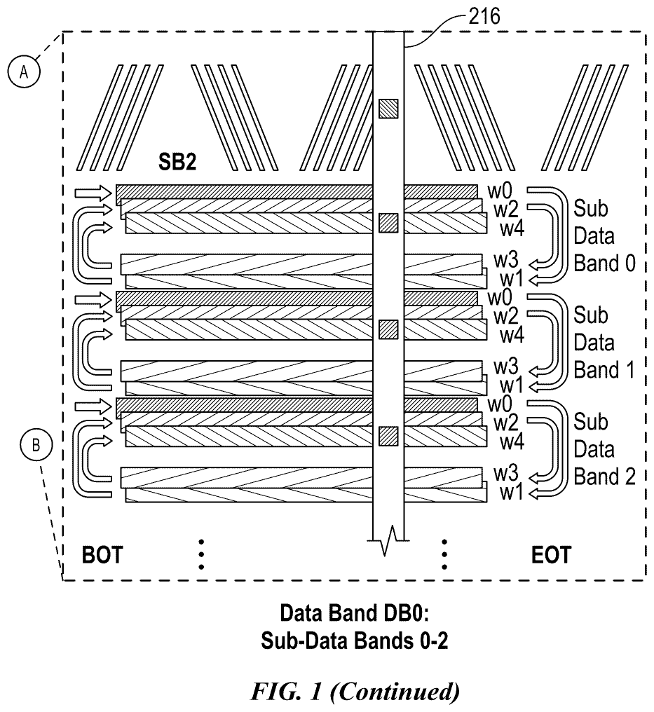

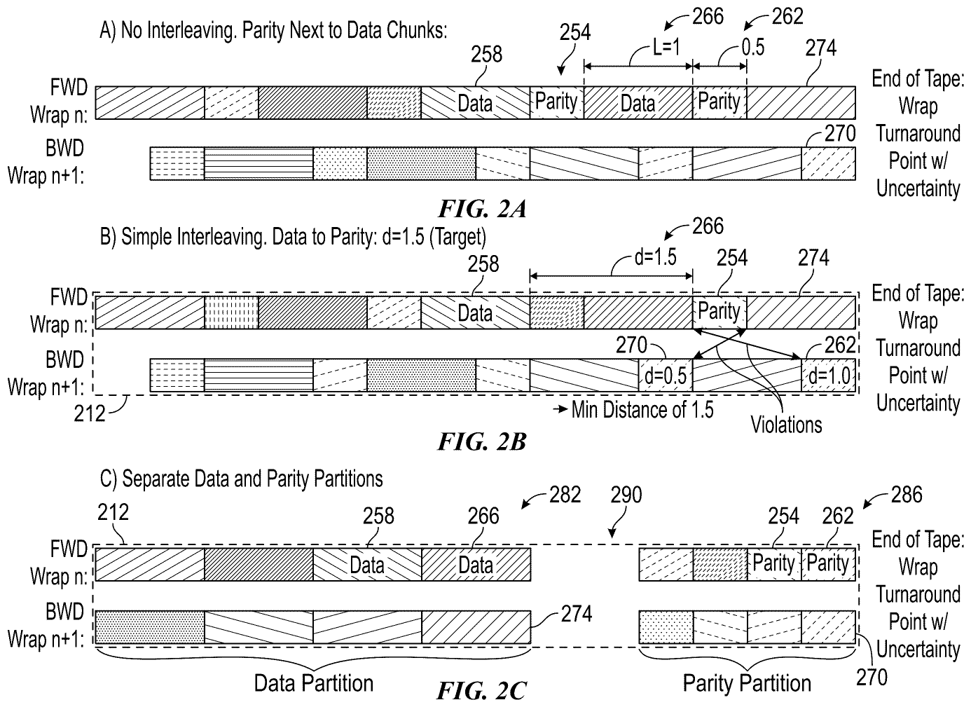

FIG. 2A illustrates data written using an in-line erasure coding and the serpentine wraps of FIG. 1. As illustrated in FIG. 2A, the parity block 254 is written immediately following the corresponding data block 258. Similarly, parity block 262 is written immediately following the corresponding data block 266. Since data block 274 is written at the end of wrap wn and parity block 270 is written at the beginning of wrap wn+1, any damage to the tape 212 at the right-side end of the tape 212 may corrupt both information of the data block 274 and the parity block 270, potentially impairing the ability to use the in-line code to recover the data of data block 274.

FIG. 2B illustrates an alternate technique for writing data using an in-line erasure coding. Simple interleaving is used to impose distance between a data block and the corresponding parity block. For example, a minimum distance that is greater than a length of the magnetic tape affected by a permanent error may be imposed between data blocks 258, 266, 274 and the corresponding parity blocks 254, 262, 270 in a linear configuration. In one example embodiment, a minimum distance of 1.5 units (where a unit (d=1) corresponds to the length of a data block in bytes and a minimum distance of 1.5 units corresponds to the length of 1.5 data blocks) may be imposed between data blocks 258, 266, 274 and the corresponding parity blocks 254, 262, 270 in a linear configuration. (It is noted that compression is not utilized in the example of FIG. 2.) Once again, however, the serpentine fashion of writing data to the tape may cause the minimum distance specification to be violated. For example, as illustrated in FIG. 2B, data block 266 is within 1 unit of parity block 262 and data block 274 is within 0.5 units of parity block 270. In addition, it is noted that the tape drive may compress the data prior to writing, potentially causing data blocks 258, 266 and parity blocks 254, 262 to become even closer together.

FIG. 2C illustrates an example tape configuration to write data using in-line erasure coding, in accordance with an example embodiment. To address the issues cited above, the tape 212 is divided into two regions: a data region 282 and a parity region 286. For the 2+1 erasure code (one parity block for each two data blocks) illustrated in FIG. 2C, the parity blocks 254, 262, 270 corresponding to the data blocks 258, 266, 274 of the data region 282 are located a safe distance away in the parity region 286. (For example tape drives, distances in the range of 10 centimeter (CM) to 100 CM are considered safe distances.) In one example embodiment, a buffer zone 290 is included between the data region 282 and the parity region 286. In example embodiments, the tape 212 is divided into more than two regions 282, 286 such that there are more than a single data region 282 and/or more than a single parity region 286. A given data region 282 and a corresponding given parity region 286 can be separated by a region filled with one or more other data regions and/or parity regions.

It is noted that there may be a substantial distance on the tape 212 between a data block 258, 266, 274 and its corresponding parity block 254, 262, 270. Thus, if a data block near the beginning of the tape 212, such as data block 258, is to be written just before ejecting the tape 212, there can be an inefficiency in relocating the tape 212 from the beginning of the tape 212 (where the data is written) toward the end of the tape 212 to write the corresponding parity block 254. In one example embodiment, the parity region 286 is written toward the beginning of the tape 212. This provides a tape access efficiency as the parity data can be written at some point during the rewinding of the tape 212 (where the rewinding is conventionally performed in preparation for the ejection of the tape 212).

It is also noted that, while using a larger number of regions 282, 286 means the parity data can potentially be located closer to its corresponding data, this configuration can make reading the data of the tape 212 less efficient as the potentially slower access to data (as a result of needing to bypass interleaved parity information) negates the faster access to the parity information (which rarely occurs since encountering errors in the data blocks 258, 266, 274 is a rare event).

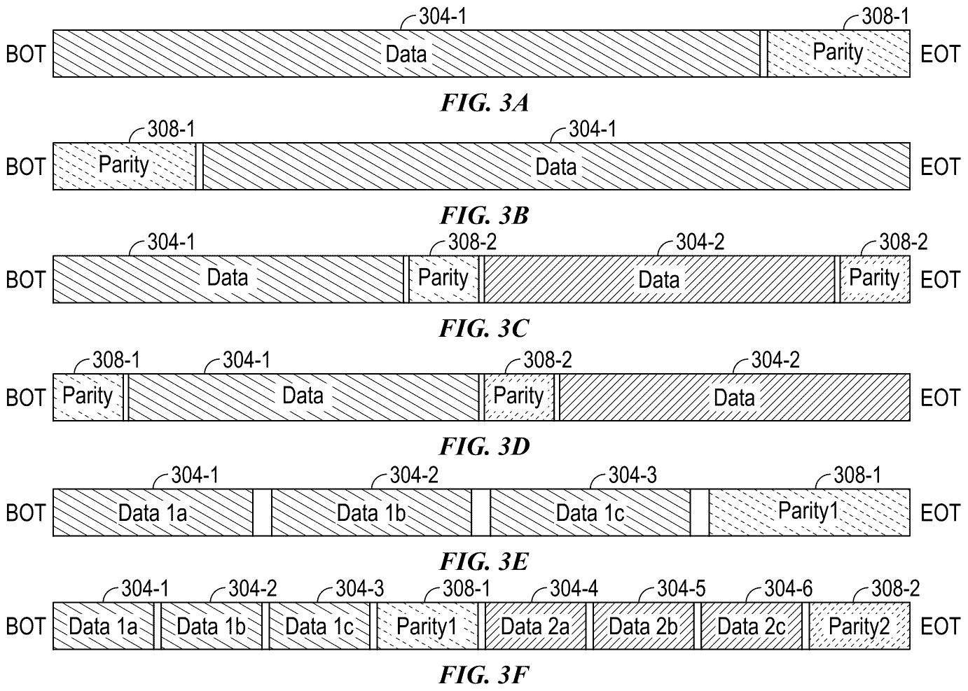

As noted above, in example embodiments, the tape 212 is divided into more than two regions 282, 286 such that there are more than a single data region 282 and/or more than a single parity region 286. A given data region 282 and a corresponding given parity region 286 can be separated by a region filled with one or more other data regions and/or parity regions. FIGS. 3A-3F illustrate example tape configurations to write data using in-line erasure coding, in accordance with example embodiments. As illustrated in FIG. 3A, a data partition 304-1 is located at the beginning of the tape 212 and a parity partition 308-1 located at the end of the tape 212 (where BOT refers to the beginning of the tape 212 and EOT refers to the end of the tape 212). As illustrated in FIG. 3B, a data partition 304-1 is located at the end of the tape 212 and a parity partition 308-1 located at the beginning of the tape 212. As illustrated in FIGS. 3C-3F, a plurality of data partitions 304-1, 304-2 and a plurality of parity partitions 308-1, 308-2 are interspersed along the length of the tape 212. The data partitions 304-1, 304-2 may be located towards the beginning of the tape 212 or towards the end of the tape 212.

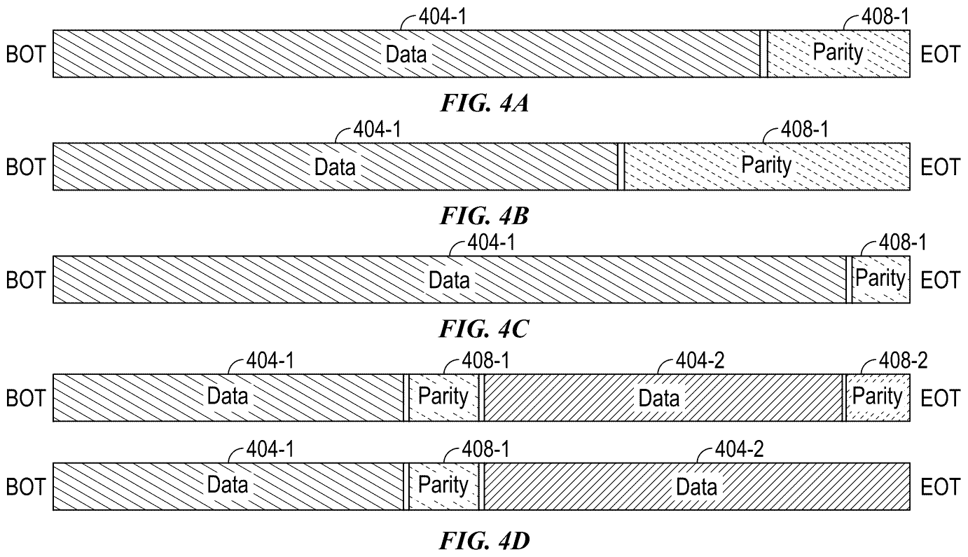

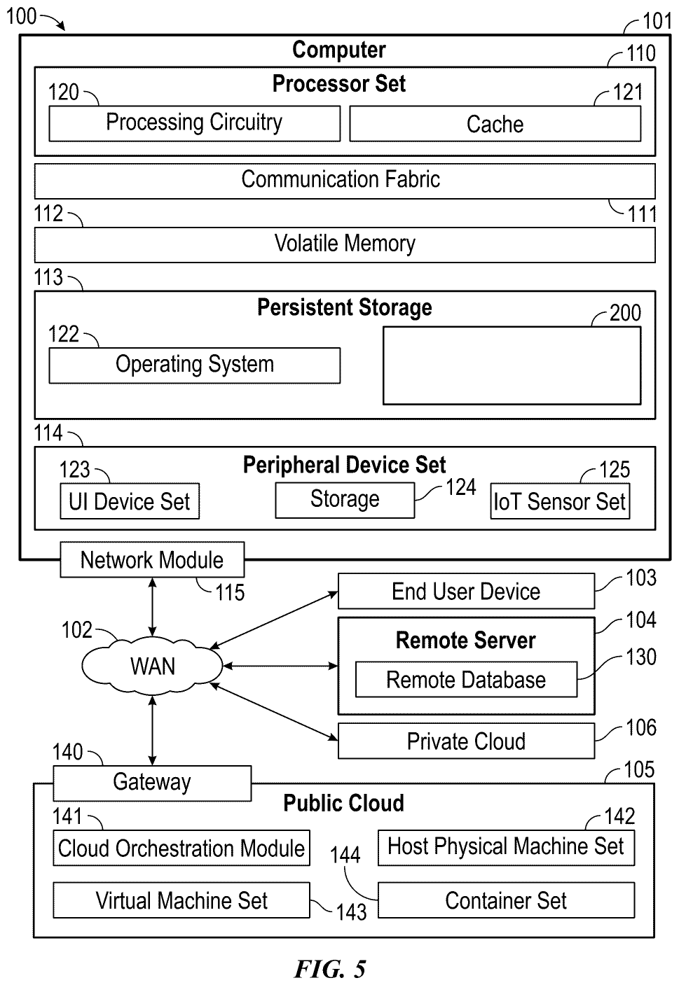

FIGS. 4A-4D illustrate example tape configurations to write data using in-line erasure coding, in accordance with example embodiments. As illustrated in FIGS. 4A-4C, the relative size of the data partitions 404-1 and parity partitions 408-1 may vary depending, for example, on the choice of erasure coding. (The relative size of the data partitions 404-1 and parity partitions 408-1 may similarly vary in the configurations of FIGS. 3A-3F and 4D.) As illustrated in FIG. 4D, data partitions, such as data partition 404-2, may have a corresponding parity partition 408-2 or may have no corresponding parity partition; that is, configurations may have at least one erasure coded region and at least one non-erasure coded region.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as storage system manager 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for storing data on a magnetic tape, comprising:
obtaining the magnetic tape, the magnetic tape defined with one or more data partitions and one or more parity partitions, wherein each of the data partitions is separated from each of the parity partitions corresponding to the given data partition by a given minimum distance, wherein each data partition comprises data information and each parity partition comprises in-line erasure coding information and wherein the given minimum distance is greater than a length of the magnetic tape affected by a permanent error; and
writing to the magnetic tape based on the one or more data partitions and the one or more parity partitions.

2. The method of claim 1, further comprising separating a given one of the data partitions from a corresponding one of the parity partitions with at least one buffer zone.

3. The method of claim 1, further comprising separating a given one of the data partitions from a corresponding one of the parity partitions with other data partitions.

4. The method of claim 1, further comprising separating a given one of the data partitions from a corresponding one of the parity partitions with other parity partitions.

5. The method of claim 1, further comprising locating at least one of the parity partitions toward a beginning of the magnetic tape in relation to the corresponding data partition.

6. The method of claim 1, further comprising locating at least one of the parity partitions toward an end of the magnetic tape in relation to the corresponding data partition.

7. The method of claim 1, wherein the one or more data partitions and one or more parity partitions are defined along a length of the magnetic tape.

8. An erasure coded magnetic tape that is partitioned along its length with one or more data partitions and one or more parity partitions, wherein the one or more data partitions are configured for storing data information and the one or more parity partitions are configured for storing parity information, wherein each of the one or more data partitions is separated from a corresponding parity partition by a given minimum distance, wherein the given minimum distance is greater than a length of the magnetic tape affected by a permanent error and wherein at least one of the data partitions is written with data and at least one of the parity partitions is written with parity information.

9. The erasure coded magnetic tape of claim 8, wherein each of the parity partitions are recorded at a beginning of the erasure coded magnetic tape relative to the corresponding data partition.

10. The erasure coded magnetic tape of claim 8, wherein each of the parity partitions are recorded at an end of the erasure coded magnetic tape relative to the corresponding data partition.

11. A storage system comprising:
a memory; and
at least one processor, coupled to said memory, and operative to perform operations comprising:
writing erasure code data to a magnetic tape with one or more data partitions and one or more parity partitions, wherein the one or more data partitions are configured for storing data information and the one or more parity partitions are configured for storing parity information, wherein each of the one or more data partitions is separated from a corresponding parity partition by a given minimum distance and wherein the given minimum distance is greater than a length of the magnetic tape affected by a permanent error.

12. The storage system of claim 11, further comprising a write head coupled to the at least one processor, which writes the erasure code under control of the at least one processor, and a tape transport coupled to the at least one processor, which transports the magnetic tape during the writing under control of the at least one processor.

13. The storage system of claim 11, the operations further comprising separating a given one of the data partitions from a corresponding one of the parity partitions with at least one buffer zone.

14. The storage system of claim 11, the operations further comprising separating a given one of the data partitions from a corresponding one of the parity partitions with other data partitions.

15. The storage system of claim 11, the operations further comprising separating a given one of the data partitions from a corresponding one of the parity partitions with other parity partitions.

16. The storage system of claim 11, the operations further comprising locating at least one of the parity partitions toward a beginning of the magnetic tape in relation to the corresponding data partition.

17. The storage system of claim 11, the operations further comprising locating at least one of the parity partitions toward an end of the magnetic tape in relation to the corresponding data partition.

18. The storage system of claim 11, wherein the one or more data partitions and one or more parity partitions are defined along a length of the magnetic tape.

19. A computer program product, comprising:
one or more tangible computer-readable storage media and program instructions stored on at least one of the one or more tangible computer-readable storage media, the program instructions executable by a processor, the program instructions comprising:
writing erasure code data to a magnetic tape with one or more data partitions and one or more parity partitions, wherein the one or more data partitions are configured for storing data information and the one or more parity partitions are configured for storing parity information, wherein each of the one or more data partitions is separated from a corresponding parity partition by a given minimum distance and wherein the given minimum distance is greater than a length of the magnetic tape affected by a permanent error.

20. The computer program product of claim 19, the program instructions further comprising separating a given one of the data partitions from a corresponding one of the parity partitions with at least one buffer zone.

21. The computer program product of claim 19, the program instructions further comprising separating a given one of the data partitions from a corresponding one of the parity partitions with other data partitions.

22. The computer program product of claim 19, the program instructions further comprising separating a given one of the data partitions from a corresponding one of the parity partitions with other parity partitions.

23. The computer program product of claim 19, the program instructions further comprising locating at least one of the parity partitions toward a beginning of the magnetic tape in relation to the corresponding data partition.

24. The computer program product of claim 19, the program instructions further comprising locating at least one of the parity partitions toward an end of the magnetic tape in relation to the corresponding data partition.

25. The computer program product of claim 19, wherein the one or more data partitions and one or more parity partitions are defined along a length of the magnetic tape.
